(19) United States
(12) Patent Application Publication
(10) Pub. No.: US 2026/0267642 A1
(43) Pub. Date: Sep. 10, 2026

(54) ARITHMETIC PROCESSING DEVICE, COMPUTER-READABLE RECORDING MEDIUM HAVING STORED THEREIN ARITHMETIC PROCESSING PROGRAM, AND COMPUTER-IMPLEMENTED ARITHMETIC PROCESSING METHOD

(71) Applicant: Fujitsu Limited, Kawasaki-shi, Kanagawa (JP)

(72) Inventor: Atsushi MIKI, Yokohama (JP)

(73) Assignee: Fujitsu Limited, Kawasaki-shi, Kanagawa (JP)

(21) Appl. No.: 19/547,413

(22) Filed: Feb. 23, 2026

(30) Foreign Application Priority Data
Mar. 7, 2025 (JP) 2025-036824

(51) Int. Cl. G06F 9/30; G06F 15/173

(52) U.S. Cl. CPC G06F 9/3001; G06F 15/173

(57) ABSTRACT

An arithmetic processing device included in a network topology, the arithmetic processing device including an arithmetic processor configured to execute arithmetic processing, and an inputting and outputting unit configured to perform optical communication with a plurality of other arithmetic processing devices included in the network topology through a plurality of ports. The arithmetic processor switches the network topology between a first network topology having a local topology in a global topology and a second network topology having only the local topology by switching connection destinations of at least some of the plurality of ports in the inputting and outputting unit.

### CROSS-REFERENCE TO RELATED APPLICATION

This application is based upon and claims the benefit of priority of the prior Japanese Patent application No. 2025-036824, filed on Mar. 7, 2025, the entire contents of which are incorporated herein by reference.

### FIELD

The present embodiment relates to an arithmetic processing device, a computer-readable recording medium having stored therein an arithmetic processing program, and a computer-implemented arithmetic processing method.

### BACKGROUND

Conventional computing infrastructures for scientific computations and simulations use parallel computers such as massively parallel computers or general-purpose computing on graphics processing unit (GPGPU) clusters. Interconnect technology is important for parallel computers to build large-scale systems and achieve high system performance. In recent years, artificial intelligence (AI)-dedicated systems have become parallel computers as their scale has expanded.

The parallel computer configuration scale depends on the node configuration, and accordingly, the network configuration in the system varies. In a system that uses a large-scale node configuration (Fat-node) to enhance individual computational performance and reduce the number of nodes accordingly, the network scale also becomes smaller. Conversely, in a system having a small-scale node configuration (Thin-node) with a large number of nodes, the network scale becomes larger. The number of AI parameters is rapidly increasing every year, and individual nodes in AI-dedicated systems tend to become increasingly Fat-node configurations in order to store the parameters in memories. The Fat-node needs a greater bandwidth, and it is estimated that, as the demand for even greater bandwidth increases, co-packaged optics (CPO) will be needed instead of active optical cable (AOC).

For example, related arts are disclosed in M. Besta and T. Hoefler, “Slim Fly: A Cost Effective Low-Diameter Network Topology,” SC '14:Proceedings of the International Conference for High Performance Computing, Networking, Storage and Analysis, New Orleans, LA, USA, 2014, pp. 348-359, and K. Lakhotia et al., “PolarFly: A Cost-Effective and Flexible Low-Diameter Topology,” SC22:International Conference for High Performance Computing, Networking, Storage and Analysis, Dallas, TX, USA, 2022, pp. 1-15

### SUMMARY

According to an aspect of the embodiments, an arithmetic processing device included in a network topology, the arithmetic processing device including an arithmetic processor configured to execute arithmetic processing, and an inputting and outputting unit configured to perform optical communication with a plurality of other arithmetic processing devices included in the network topology through a plurality of ports, wherein the arithmetic processor switches the network topology between a first network topology having a local topology in a global topology and a second network topology having only the local topology by switching connection destinations of at least some of the plurality of ports in the inputting and outputting unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating Slim Fly, which is a network topology of a direct network in a conventional example;

FIG. 2 is a diagram illustrating PolarFly, which is a network topology of a direct network in a conventional example;

FIG. 3 is a diagram illustrating an example of a first configuration of an arithmetic processing device in a related example;

FIG. 4 is a diagram illustrating an example of a second configuration of an arithmetic processing device in a related example;

FIG. 5 is a diagram illustrating an example of a third configuration of an arithmetic processing device in a related example;

FIG. 6 is a diagram illustrating an example of a configuration of a first network topology in an arithmetic processing device according to an embodiment;

FIG. 7 is a diagram illustrating an example of a configuration of a second network topology in an arithmetic processing device according to an embodiment;

FIG. 8 is a diagram illustrating an example of a configuration of virtual channels of PolarFly and Hypercube in an embodiment;

FIG. 9 is a flowchart for explaining a failure detour process according to an embodiment;

FIG. 10 is a diagram for explaining an example of detouring in the failure detour process according to an embodiment;

FIG. 11 is a table exemplifying a cost for each transmission medium in a network topology;

FIG. 12 is a table exemplifying a network cost and an injection bandwidth in each of the network topologies illustrated in FIGS. 3-7; and

FIG. 13 is a graph exemplifying a relationship between the number of nodes and a bisection bandwidth in each of the network topologies illustrated in FIGS. 3-7.

### DESCRIPTION OF EMBODIMENTS

CPO has a high signal density, which has the advantage of fewer restrictions on implementation as compared with AOC. However, in a case where CPO is employed in an indirect network, integration of CPO on the switch side is also needed, which leads to an increase in network cost.

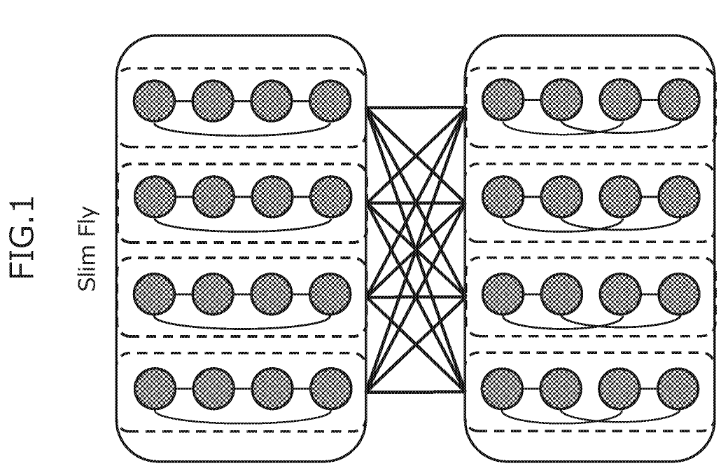

FIG. 1 is a diagram illustrating Slim Fly, which is a network topology of a direct network in a conventional example.

Slim Fly as illustrated in FIG. 1 is proposed as a topology that can realize a direct network, and can reduce cost and reduce latency and energy consumption by reducing a network diameter (for example, Non Patent Document 1). However, complicated wiring between local groups needs to be stored in the rack, which increases restrictions on implementation.

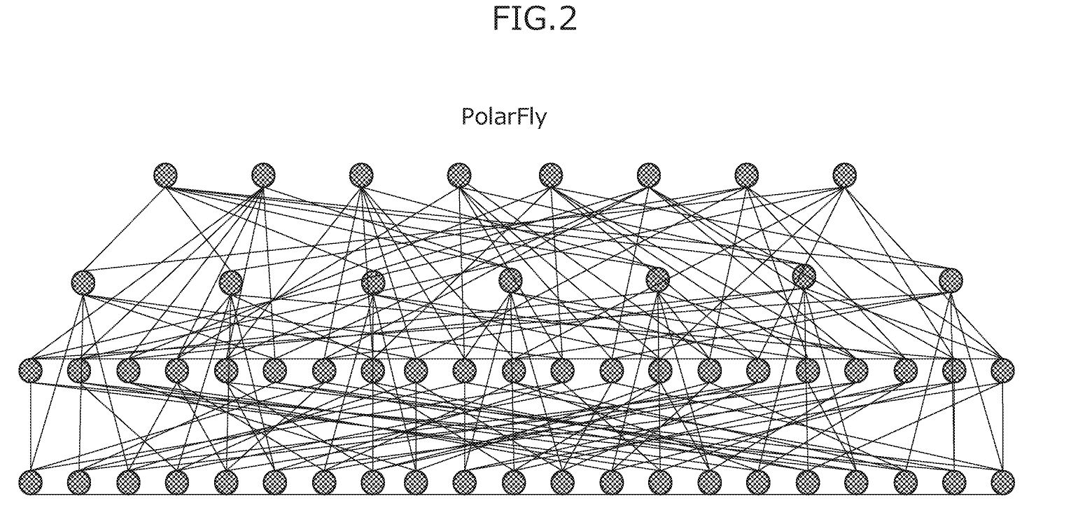

FIG. 2 is a diagram illustrating PolarFly, which is a network topology of a direct network in a conventional example.

PolarFly as illustrated in FIG. 2 is proposed as a topology having a shorter diameter than Slim Fly while improving the restrictions on implementation (for example, Non Patent Document 2).

Each node has a left-normalized vector composed of three elements on a finite field as an address, and nodes are connected when the inner product of their vectors is 0. The properties of the left-normalized vectors guarantee that any vectors are orthogonal or have a common orthogonal vector. Therefore, any nodes are connected within two hops. However, there is a problem that scalability is insufficient. In the PolarFly configured using left-normalized vectors on the finite field F7 as illustrated in FIGS. 2, 57 nodes are connected. The needed number of ports is 8 per node.

### A. Related Example

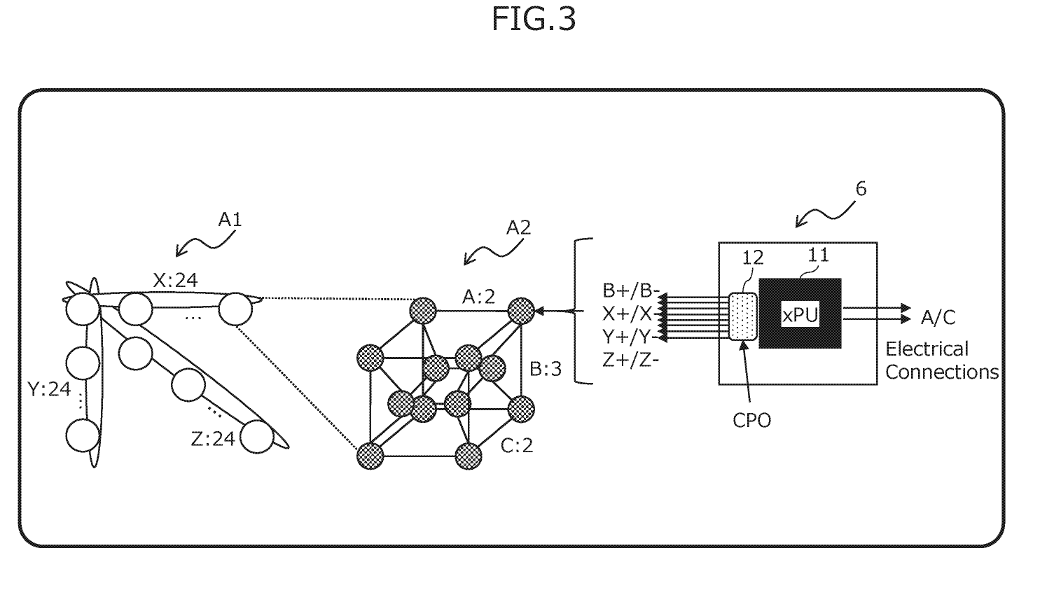

FIG. 3 is a diagram illustrating an example of a first configuration of an arithmetic processing device 6 in a related example.

The network topology to which the arithmetic processing device 6 illustrated in FIG. 3 is applied may be referred to as 6D Torus, and the number of coordinates in the X-axis direction is 24, the number of coordinates in the Y-axis direction is 24, and the number of coordinates in the Z-axis direction is 24 as indicated by reference sign A1.

In addition, each node indicated by reference sign A1 has two coordinates in the A-axis direction, three coordinates in the B-axis direction, and two coordinates in the C-axis direction as in the network topology indicated by reference sign A2.

Therefore, 6D Torus illustrated in FIG. 3 has 2x3x2x24x24x24 dimensions, which is highly scalable and suitable for high performance computing (HPC).

The arithmetic processing device 6 includes an x processing unit (xPU) 11 and a CPO 12 connected to the xPU 11.

Two ports (in other words, electrical connections) in the A/C axis direction are set from the xPU 11. In addition, eight ports in the B+/B-, X+/X-, Y+/Y-, and Z+/Z- axis directions are set from the CPO 12. Hereinafter, FIGS. 3-7 are examples when the CPO12 has eight cores.

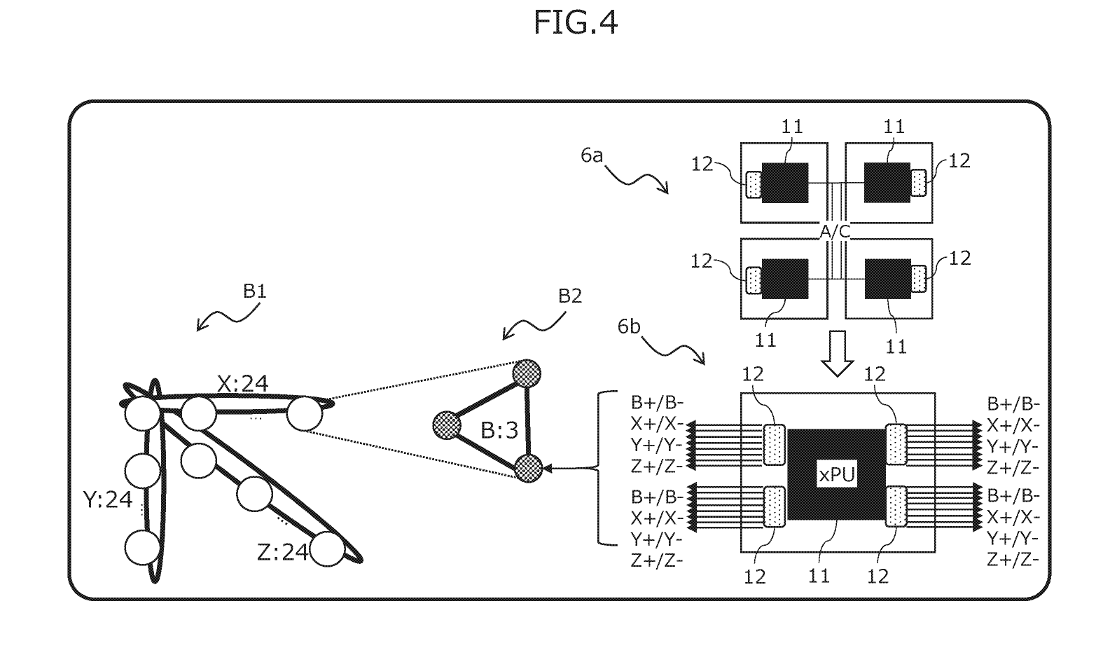

FIG. 4 is a diagram illustrating an example of a second configuration of an arithmetic processing device 6a or 6b in a related example.

The network topology to which the arithmetic processing device 6a or 6b illustrated in FIG. 4 is applied may be referred to as Quad-rail 4D-Torus, and the number of coordinates in the X-axis direction is 24, the number of coordinates in the Y-axis direction is 24, and the number of coordinates in the Z-axis direction is 24 as indicated by reference sign B1.

In addition, each node indicated by reference sign B1 has three coordinates in the B-axis direction as in the network topology indicated by reference sign B2.

Therefore, Quad-rail 4D-Torus illustrated in FIG. 4 has 3×24×24×24 dimensions, and has a configuration that integrates every four nodes of 6D-Torus, providing a large memory capacity and being suitable for AI.

The arithmetic processing device 6a includes four xPUs 11. Each xPU 11 includes one CPO 12 and is connected to the other xPUs 11 by ports in the A/C axis direction.

The arithmetic processing device 6a may have a configuration of the arithmetic processing device 6b.

The arithmetic processing device 6b includes one x processing unit (xPU) 11 and four CPOs 12 connected to the xPU 11.

Eight ports in the B+/B-, X+/X-, Y+/Y-, and Z+/Z- axis directions are set from each of the CPOs 12. Therefore, 8x4=32 ports are set for the entire arithmetic processing device 6b.

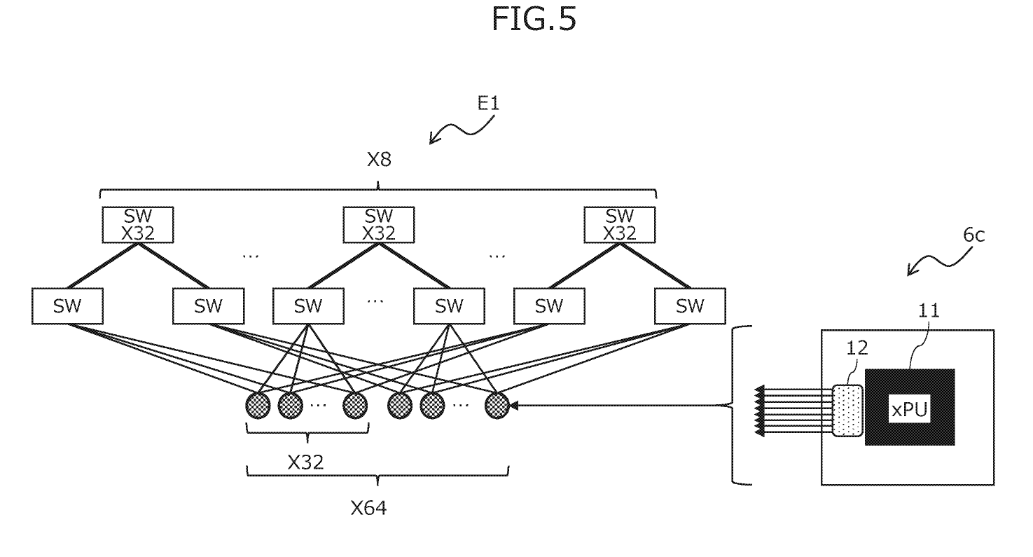

FIG. 5 is a diagram illustrating an example of a third configuration of an arithmetic processing device in a related example.

The network topology to which the arithmetic processing device 6c illustrated in FIG. 5 is applied may be referred to as Oct-rail Fat-tree. The network topology indicated by reference sign E1 has 32x64=2048 nodes, with a total of 768 switches (SWs) including 8x64=512 SWs directly connected to each node and 8x32=256 SWs on the upper level.

Therefore, Oct-rail Fat-tree illustrated in FIG. 5 is a 64-port switch two-stage Fat-tree, and eight cores of Tera-PHY are branched to form an eight-layer Fat-tree. When the bandwidth of one port of the SW is set to 512 Gbps to match the CPOs 12, 64 ports (not up to 128 ports) are regarded as appropriate.

The arithmetic processing device 6c includes an xPU 11 and a CPO 12 connected to the xPU 11. Eight ports are set from the CPO 12.

### B. Embodiment

Hereinafter, an embodiment will be described with reference to the drawings. However, the embodiment described below is merely an example, and there is no intention to exclude the application of various modifications and techniques that are not explicitly described in the embodiment. That is, the present embodiment can be variously modified and implemented without departing from the gist thereof. Each drawing is not intended to include only the components illustrated in the drawing, but may include other functions and the like.

Hereinafter, in the drawings, the same reference signs denote the same parts, and thus the description thereof will be omitted.

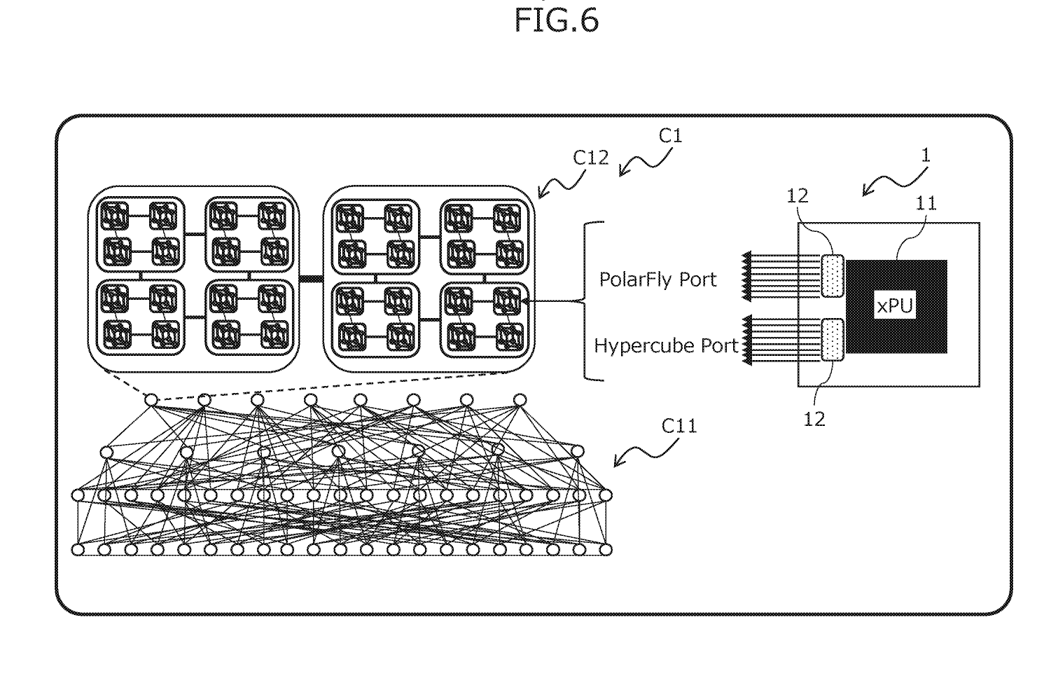

FIG. 6 is a diagram illustrating an example of a configuration of a first network topology in an arithmetic processing device 1 according to the embodiment.

PolarFly illustrated in FIG. 2 has a short diameter in the direct network, and has few restrictions on implementation, but is insufficient in scalability.

Therefore, a topology in which PolarFly and Hypercube are combined is considered. That is, Hypercube is a local group, which is connected with PolarFly.

It is possible to configure a POD taking advantage of the short diameter property of PolarFly for HPC and the tight coupling of Hypercube for AI. The POD is assumed to be configured with 64 or fewer nodes using Fat-node.

However, in consideration of scalability for HPC, the entire system is assumed to have several thousand nodes. Therefore, it is considered to combine PolarFly on F7 and seven-dimensional Hypercube. 57 local groups, each consisting of 128 nodes, are connected, and therefore, the entire system includes 7296 nodes.

The first network topology illustrated in FIG. 6 may be referred to as PolarFly+, and 8D-Hypercube (reference sign C12) is set in each node of PolarFly (reference sign C11) as indicated by reference sign C1.

The arithmetic processing device 1 includes an xPU 11 and two CPOs 12 connected to the xPU 11.

The xPU 11 is an example of an arithmetic processor, and executes arithmetic processing.

The CPO 12 is an example of an inputting and outputting unit, and performs optical communication with a plurality of other xPUs 11 included in the network topology through a plurality of ports.

In the first network topology illustrated in FIG. 6, eight ports for PolarFly are configured in one of the two CPOs 12, and eight ports for Hypercube are configured in the other.

PolarFly on F7 needs eight ports per node, whereas seven-dimensional Hypercube uses seven ports, needing a total of 15 ports.

However, considering that the Tera-PHY has eight cores, Hypercube may also be prepared with eight ports, with one port as a spare port for expansion. That is, 16 fibers may be allocated to the 16 ports, respectively, using 2 Tera-PHYs per node.

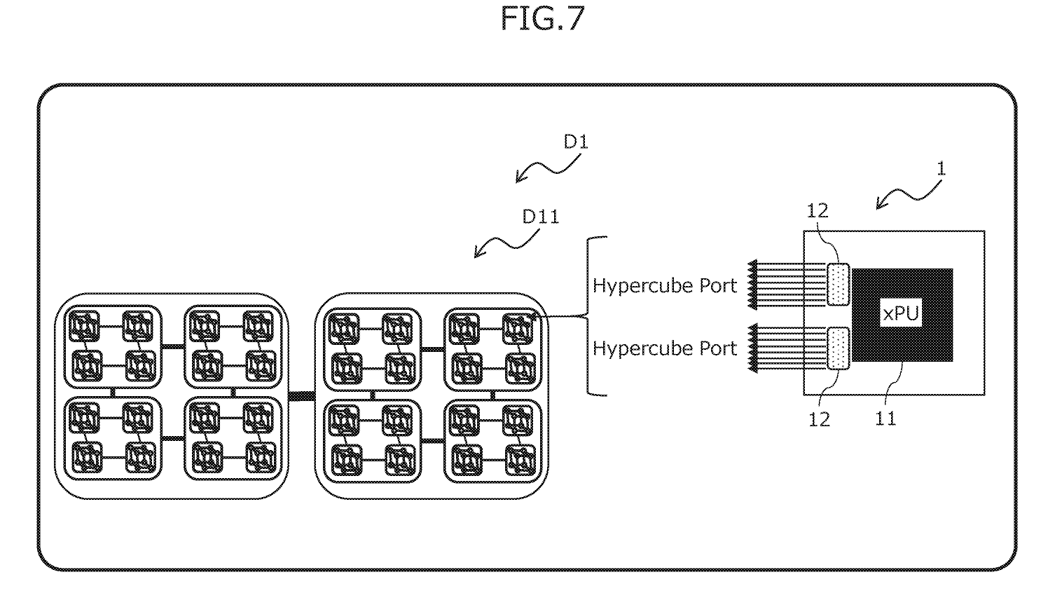

FIG. 7 is a diagram illustrating an example of a configuration of a second network topology in an arithmetic processing device 1 according to the embodiment.

The second network topology indicated by reference sign D1 in FIG. 7 may be referred to as a PolarFly+ AI POD, and is configured by a tightly coupled POD with multiple Hypercube using all ports as indicated by reference sign D11.

In the second network topology illustrated in FIG. 7, both two CPOs 12 are configured as ports for Hypercube.

That is, 8x2=16 ports are set for Hypercube.

The xPU 11 may be switchable between the first network topology (PolarFly+) illustrated in FIG. 6 and the second network topology (PolarFly+ AI POD) illustrated in FIG. 7. The xPU 11 switches one of the two CPOs 12 to be used for PolarFly or Hypercube, and fixes the other to be used for Hypercube.

In other words, the xPU 11 switches connection destinations of at least some of the plurality of ports in the CPO 12. As a result, the xPU 11 switches the network topology between the first network topology having a local topology (Hypercube) in a global topology (PolarFly+) and the second network topology having only the local topology (Hypercube).

The xPU 11 may be, for example, any one of a CPU, an MPU, a DSP, an ASIC, a PLD, and an FPGA. In addition, the xPU 11 may be a combination of two or more types of the CPU, the MPU, the DSP, the ASIC, the PLD, and the FPGA. Note that the CPU is an abbreviation for central processing unit, the MPU is an abbreviation for micro processing unit, DSP is an abbreviation for digital signal processor, and ASIC is an abbreviation for application specific integrated circuit. In addition, the PLD is an abbreviation for programmable logic device, and the FPGA is an abbreviation for field programmable gate array.

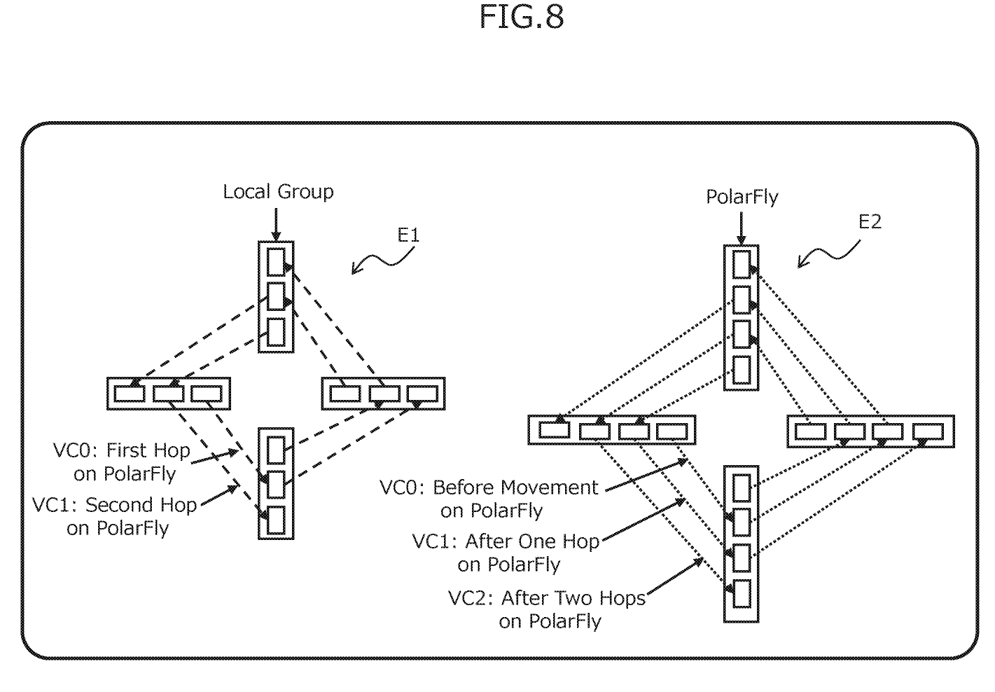

FIG. 8 is a diagram illustrating an example of a configuration of virtual channels of PolarFly and Hypercube according to the embodiment.

Routing on PolarFly+ is divided into movement on PolarFly and movement on Hypercube.

The movement on PolarFly occurs up to two times. Reference sign E1 in FIG. 8 indicates a state in which local groups configured by Hypercube are connected in a ring shape, and it is possible to avoid deadlocks by separating virtual channels (VCs) into a first hop channel and a second hop channel on PolarFly. However, in order to return a response to a request, two VCs are needed for each of the request and the response.

The movement on Hypercube occurs up to three times. PolarFly+ can also be regarded as PolarFly connected with Hypercube. Reference sign E2 in FIG. 8 indicates a state in which PolarFly is connected in a ring shape with Hypercube.

In order to avoid deadlocks, it is only needed to separate VCs into a VC before a movement occurs in the PolarFly, a VC after one hop in the PolarFly, and a VC after two hops in the PolarFly. Therefore, three VCs are needed for each of the request and the response.

In other words, given that (n+1)×2 virtual channels are needed for routing the local topology and n×2 virtual channels are needed for routing the global topology, n (n is a natural number) being a minimum number of hops in the global topology, each of the plurality of ports includes (n+1)×2 virtual channels and performs optical communication with the plurality of arithmetic processing devices 1.

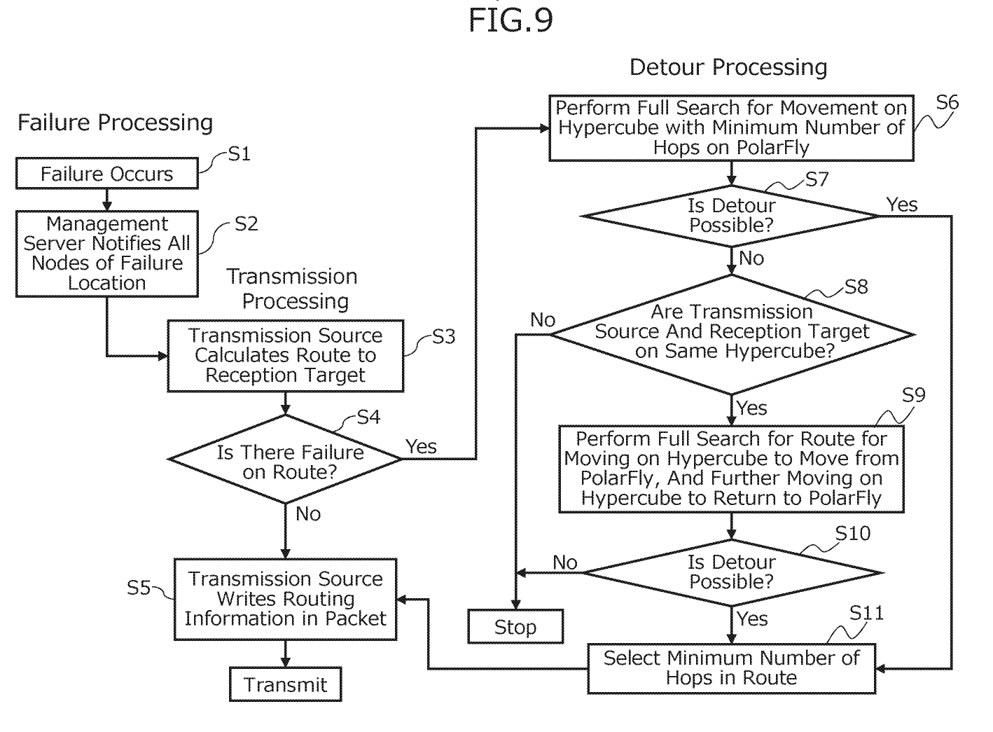

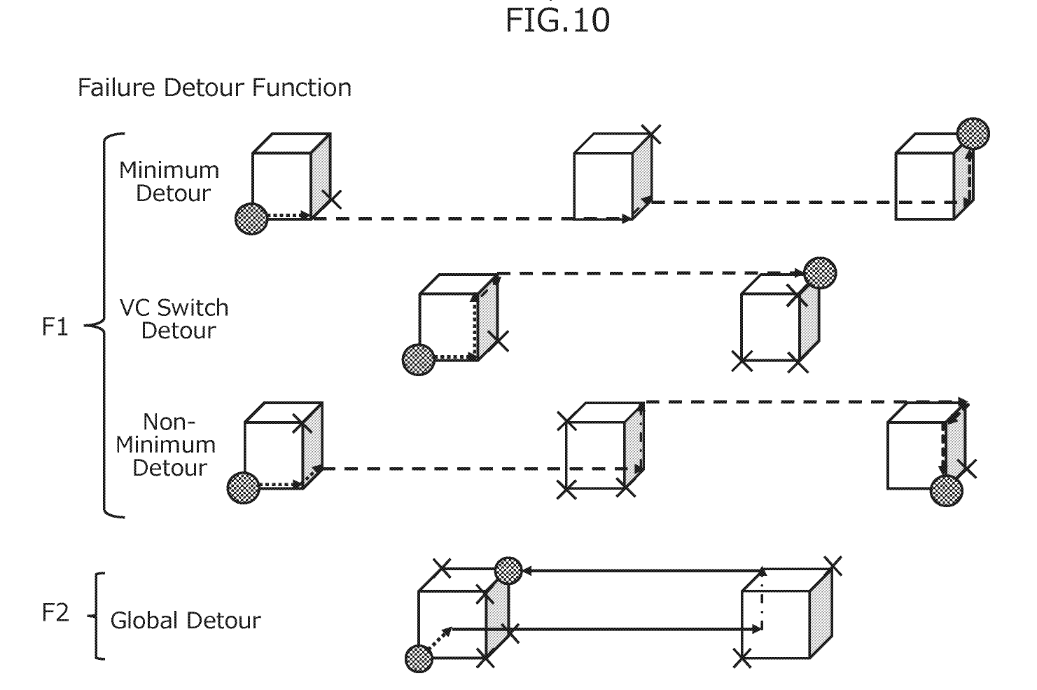

A failure detour process in the embodiment configured as described above will be described according to a flowchart (steps S1 to S11) illustrated in FIG. 9 with reference to FIG. 10. FIG. 10 is a diagram for explaining an example of detouring in the failure detour process according to the embodiment.

In failure processing (steps S1 and S2), when a failure occurs (step S1), a management server (e.g., an xPU 11 of a certain node) notifies all the nodes of the failure location (step S2).

In transmission processing (steps S3 to S5), an xPU 11 of a transmission source node calculates a route to a reception target (step S3).

The xPU 11 of the transmission source node determines whether there is a failure on the route (step S4).

When there is no failure on the route (see No route in step S4), the xPU 11 of the transmission source node writes routing information in a packet (step S5), executes transmission, and ends the failure detour process.

On the other hand, when there is a failure on the route (see Yes route in step S4), the process proceeds to detour processing (steps S6 to S11).

The xPU 11 of the transmission source node performs a full search for movement on Hypercube with a minimum number of hops on PolarFly (step S6). The full search for movement on Hypercube includes a minimum detour, a VC switch detour and a non-minimum detour indicated by reference sign F1 in FIG. 10.

In FIG. 10, “X” represents a failure location.

In other words, when a malfunction occurs in a route to a target xPU 11 among the plurality of xPUs 11, the xPU 11 searches for a first detour route for passing through the local topology once.

The xPU 11 of the transmission source node determines whether the detour is possible (step S7).

When the detour is possible (see Yes route in step S7), the process proceeds to step S11.

When the detour is not possible (see No route in step S7), the xPU 11 of the transmission source node determines whether the transmission source node and the reception target node are on the same Hypercube (step S8).

When the transmission source node and the reception target node are not on the same Hypercube (see No route in step S8), the failure detour process stops and ends.

On the other hand, when the transmission source node and the reception target node are on the same Hypercube (see Yes route in step S8), the xPU 11 of the transmission source node performs a full search for a path for moving on Hypercube to move from PolarFly, and further moving on Hypercube to return to PolarFly (step S9). The full search for the path for moving on Hypercube to move from PolarFly, and further moving on Hypercube to return to PolarFly includes a global detour indicated by reference sign F2 in FIG. 10.

In other words, when the first detour route is not available and one xPU 11 and the target xPU 11 are located in the same local topology, the xPU 11 searches for a second detour route for returning from the same local topology to the same local topology through another local topology.

The xPU 11 of the transmission source node determines whether the detour is possible (step S10).

When the detour is not possible (see No route in step S10), the failure detour process stops and ends.

On the other hand, when the detour is possible (see Yes route in step S10), the xPU 11 of the transmission source node selects a minimum number of hops in the route (step S11), and the process proceeds to step S5.

### C. Effects

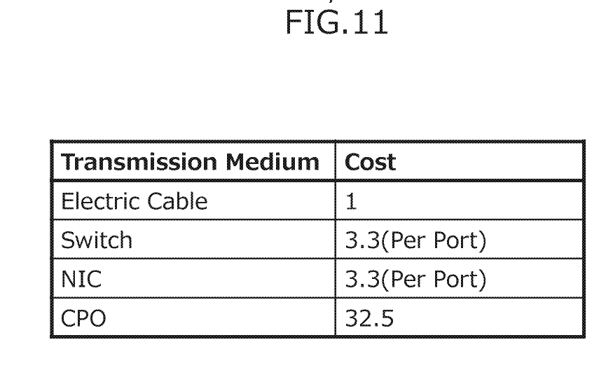

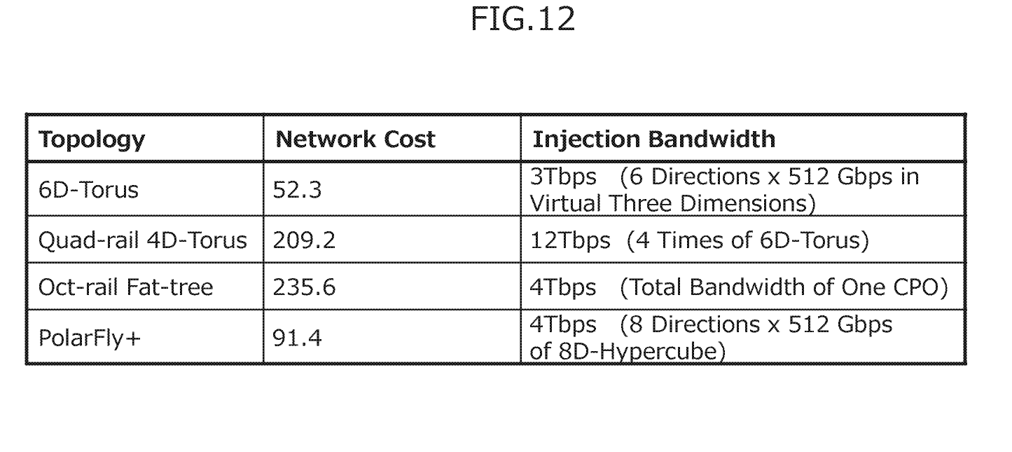

FIG. 11 is a table exemplifying a cost for each transmission medium in the network topology. FIG. 12 is a table exemplifying a network cost and an injection bandwidth in each of the network topologies illustrated in FIGS. 3-7.

As illustrated in FIG. 11, when the cost of the electric cable is 1, the cost of the switch per port is 3.3, the cost of the network interface card (NIC) per port is 3.3, and the cost of the CPO is 32.5.

FIG. 12 illustrates a network topology cost when the cost of each transmission medium illustrated in FIG. 11 is applied to each of the network topologies illustrated in FIGS. 3-7. In addition, the injection bandwidth illustrated in FIG. 12 is an example when the bandwidth of the CPO 12 is 8 cores and 4 Tbps.

The network cost of 6D-Torus illustrated in FIG. 3 is 52.3, and the injection bandwidth is 3 Tbps (6 directions x 512 Gbps in virtual three dimensions).

The network cost of Quad-rail 4D-Torus illustrated in FIG. 4 is 209.2, and the injection bandwidth is 12 Tbps (4 times of 6D-Torus).

The network cost of Oct-rail Fat-tree illustrated in FIG. 5 is 235.6, and the injection bandwidth is 4 Tbps (total bandwidth of one CPO).

The network cost of PolarFly+ illustrated in FIGS. 6 and 7 is 91.4, and the injection bandwidth is 4 Tbps (8 directions x 512 Gbps of 8D-Hypercube).

In this manner, when compared in the ratio of injection bandwidth to cost, the costs of 6D-Torus, Quad-rail 4D-Torus, and PolarFly+ are similar, while the cost of Oct-rail Fat-tree is high.

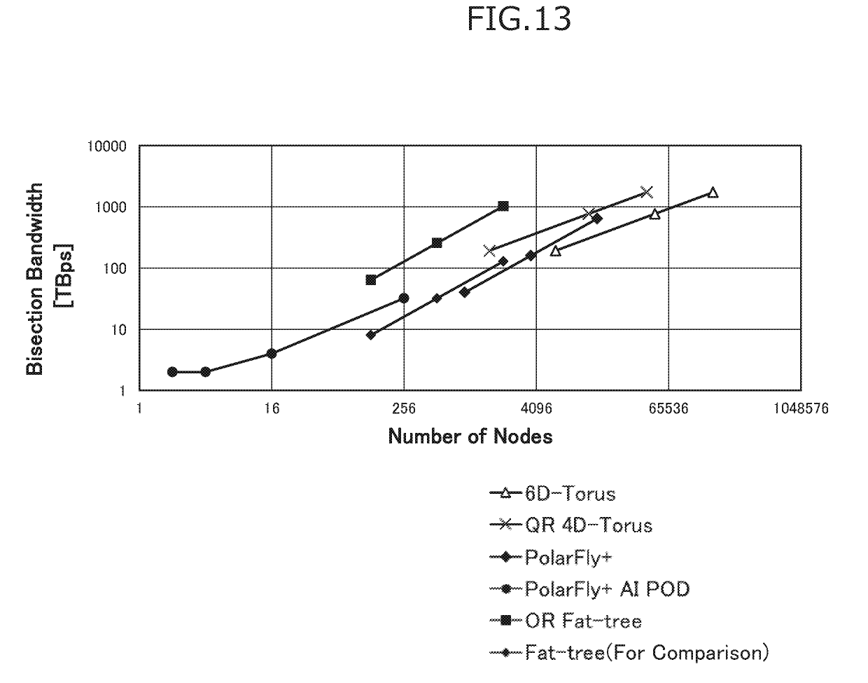

FIG. 13 is a graph exemplifying a relationship between the number of nodes and a bisection bandwidth in each of the network topologies illustrated in FIGS. 3 to 7.

In FIG. 13, for 6D-Torus and QR 4D-Torus (Quad-rail 4D-Torus), bisection bandwidths (BBWs) are plotted in a configuration in which the sizes of the X, Y, and Z axes are 24 coordinates, 16 coordinates, and 8 coordinates.

PolarFly+ differs between the application for HPC (PolarFly+) and the application for AI (PolarFly+ AI POD). PolarFly is used in the application for HPC, but eight ports for PolarFly are switched to ports for Hypercube in the application for AI, and all 16 ports of each node are used to configure a POD of Hypercube.

For PolarFly+, BBWs are plotted in a configuration in which Hypercube is structured in eight dimensions, six dimensions, and four dimensions. For PolarFly+ AI POD, BBWs are plotted for a 256-node POD in which 2 ports are allocated to one dimension, a 16-node POD in which 4 ports are allocated to one dimension, a 4-node POD in which 8 ports are allocated to one dimension, and a 2-node POD in which all 16 ports are allocated to one dimension.

For OR Fat-tree (Oct-rail Fat-tree), BBWs are plotted in a 2048 node configuration, a 512 node configuration, and a 128 node configuration. For comparison, BBWs for Fat-tree in the same number of nodes are also plotted.

In 6D-Torus and QR 4D-Torus, the cost and the injection bandwidth (IBW) have a proportional relationship. However, 6D-Torus is suitable for HPC applications because it has a thin-node configuration with a large number of nodes, whereas 4D-Torus is also suitable for a configuration of an AI POD because a Fat-node configuration in which four nodes of 6D-Torus are integrated into one node is connected in a broadband of Quad-rail.

Quad-plane 4D-Torus uses four Tera-PHYs per node, resulting in a higher BBW than 6D-Torus in the same number of nodes.

OR Fat-tree has the highest BBW, but its network cost is too high. In normal Fat-tree that is not multiplexed, the network cost is 1/8, but the BBW is also 1/8. In addition, it can connect only up to 2048 nodes, and its scalability is insufficient for HPC.

PolarFly+ has a BBW equivalent to that of QR 4D-Torus or Fat-tree. However, its network cost is half that of QR 4D-Torus, and its scalability is higher than that of Fat-tree. PolarFly+ AI POD, which is a multiplexed Hypercube, can achieve a higher BBW than Fat-tree, without changing the network cost, when compared with the same number of nodes.

That is, it is considered that PolarFly+ AI POD is appropriate for AI applications with up to 256 nodes, while PolarFly+ is appropriate for HPC applications with up to 14592 nodes.

According to the arithmetic processing device 1 in the above-described embodiment, for example, the following effects can be obtained.

The xPU 11 switches the network topology between a first network topology having a local topology in a global topology and a second network topology having only the local topology by switching connection destinations of at least some of the plurality of ports in the CPO 12.

As a result, the scalability of the network topology can be improved. In addition, the ratio of injection bandwidth to cost can be improved.

Given that (n+1)×2 virtual channels are needed for routing the local topology and n×2 virtual channels are needed for routing the global topology, n (n is a natural number) being a minimum number of hops in the global topology, each of the plurality of ports includes (n+1)×2 virtual channels and performs optical communication with the plurality of arithmetic processing devices.

As a result, deadlocks caused by routing can be avoided.

When a malfunction occurs in a route to a target xPU 11 among the plurality of xPUs 11, the xPU 11 searches for a first detour route for passing through the local topology once.

As a result, when a malfunction such as a failure occurs, it is possible to search for a detour route with the shortest path as much as possible.

When the first detour route is not available and one xPU 11 and the target xPU 11 are located in the same local topology, the xPU 11 searches for a second detour route for returning from the same local topology to the same local topology through another local topology.

As a result, even when the detour route with the short path is not available, the likelihood of finding a detour route can be improved.

### D. Others

The disclosed technology is not limited to the above-described embodiment, and various modifications can be made without departing from the gist of the present embodiment. Each configuration and each process of the present embodiment can be selected or omitted as needed or may be appropriately combined.

In one aspect, the scalability of the network topology can be improved.

Throughout the descriptions, the indefinite article "a" or "an" does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An arithmetic processing device included in a network topology, the arithmetic processing device comprising:
an arithmetic processor configured to execute arithmetic processing; and
an inputting and outputting unit configured to perform optical communication with a plurality of other arithmetic processing devices included in the network topology through a plurality of ports,
wherein the arithmetic processor switches the network topology between a first network topology having a local topology in a global topology and a second network topology having only the local topology by switching connection destinations of at least some of the plurality of ports in the inputting and outputting unit.

2. The arithmetic processing device according to claim 1, wherein
given that (n+1)×2 virtual channels are needed for routing the local topology and n×2 virtual channels are needed for routing the global topology, n (n is a natural number) being a minimum number of hops in the global topology, each of the plurality of ports includes (n+1)×2 virtual channels and performs optical communication with the plurality of other arithmetic processing devices.

3. The arithmetic processing device according to claim 1, wherein
when a malfunction occurs in a route to a destination arithmetic processing device among the plurality of other arithmetic processing devices, the arithmetic processor searches for a first detour route for passing through the local topology once.

4. The arithmetic processing device according to claim 2, wherein
when a malfunction occurs in a route to a destination arithmetic processing device among the plurality of other arithmetic processing devices, the arithmetic processor searches for a first detour route for passing through the local topology once.

5. The arithmetic processing device according to claim 3, wherein
when the first detour route is not available and the arithmetic processing device and the destination arithmetic processing device are located in the same local topology, the arithmetic processor searches for a second detour route for returning from the same local topology to the same local topology through another local topology.

6. The arithmetic processing device according to claim 4, wherein
when the first detour route is not available and the arithmetic processing device and the destination arithmetic processing device are located in the same local topology, the arithmetic processor searches for a second detour route for returning from the same local topology to the same local topology through another local topology.

7. A computer-readable recording medium having stored therein an arithmetic processing program causing a computer at one node included in a network topology to execute:
switching the network topology between a first network topology having a local topology in a global topology and a second network topology having only the local topology by switching connection destinations of at least some of a plurality of ports for performing optical communication with a plurality of other nodes included in the network topology.

8. The computer-readable recording medium having stored therein the arithmetic processing program according to claim 6, wherein
given that (n+1)×2 virtual channels are needed for routing the local topology and n×2 virtual channels are needed for routing the global topology, n (n is a natural number) being a minimum number of hops in the global topology, each of the plurality of ports includes (n+1)×2 virtual channels and performs optical communication with the plurality of other arithmetic processing devices.

9. The computer-readable recording medium having stored therein the arithmetic processing program according to claim 7, wherein
when a malfunction occurs in a route to a destination arithmetic processing device among the plurality of other arithmetic processing devices, the arithmetic processor searches for a first detour route for passing through the local topology once.

10. The computer-readable recording medium having stored therein the arithmetic processing program according to claim 8, wherein
when a malfunction occurs in a route to a destination arithmetic processing device among the plurality of other arithmetic processing devices, the arithmetic processor searches for a first detour route for passing through the local topology once.

11. The computer-readable recording medium having stored therein the arithmetic processing device according to claim 9, wherein
when the first detour route is not available and the arithmetic processing device and the destination arithmetic processing device are located in the same local topology, the arithmetic processor searches for a second detour route for returning from the same local topology to the same local topology through another local topology.

12. The computer-readable recording medium having stored therein the arithmetic processing device according to claim 10, wherein
when the first detour route is not available and the arithmetic processing device and the destination arithmetic processing device are located in the same local topology, the arithmetic processor searches for a second detour route for returning from the same local topology to the same local topology through another local topology.

13. A computer-implemented arithmetic processing method performed by a computer at one node included in a network topology, the arithmetic processing method comprising:
switching the network topology between a first network topology having a local topology in a global topology and a second network topology having only the local topology by switching connection destinations of at least some of a plurality of ports for performing optical communication with a plurality of other nodes included in the network topology.

14. The computer-implemented arithmetic processing device according to claim 13, wherein
given that (n+1)×2 virtual channels are needed for routing the local topology and n×2 virtual channels are needed for routing the global topology, n (n is a natural number) being a minimum number of hops in the global topology, each of the plurality of ports includes (n+1)×2 virtual channels and performs optical communication with the plurality of other arithmetic processing devices.

15. The computer-implemented arithmetic processing method according to claim 13, wherein
when a malfunction occurs in a route to a destination arithmetic processing device among the plurality of other arithmetic processing devices, the arithmetic processor searches for a first detour route for passing through the local topology once.

16. The computer-implemented arithmetic processing method according to claim 14, wherein
when a malfunction occurs in a route to a destination arithmetic processing device among the plurality of other arithmetic processing devices, the arithmetic processor searches for a first detour route for passing through the local topology once.

17. The computer-implemented arithmetic processing method according to claim 15, wherein
when the first detour route is not available and the arithmetic processing device and the destination arithmetic processing device are located in the same local topology, the arithmetic processor searches for a second detour route for returning from the same local topology to the same local topology through another local topology.

18. The computer-implemented arithmetic processing method according to claim 16, wherein
when the first detour route is not available and the arithmetic processing device and the destination arithmetic processing device are located in the same local topology, the arithmetic processor searches for a second detour route for returning from the same local topology to the same local topology through another local topology.
